(19) United States
(12) Patent Application Publication
(10) Pub. No.: US 2013/0174404 A1
(43) Pub. Date: Jul. 11, 2013

(54) Method for connecting two coaxial tubular parts, tool for producing such a connection and use

(71) Applicant: Claude Bonnot, Triors (FR)

(72) Inventor: Claude Bonnot, Triors (FR)

(21) Appl. No.: 13/694,828

(22) Filed: Jan. 10, 2013

Related U.S. Application Data
(63) Continuation of application No. 10/470,614, now abandoned.
Application No. 10/470,614 is a continuation of application No. 09/868,876, filed on Jun. 22, 2001, now abandoned.

(30) Foreign Application Priority Data
Dec. 22, 1998 (FR) 98 16263

(51) Int. Cl. B21D 39/04; B23P 11/00

(52) U.S. Cl. CPC B21D 39/04; B23P 11/005
USPC 29/523; 29/283.5

(57) ABSTRACT

The invention concerns a method which consists in producing by radial expansion of the walls of two tubular parts (1, 2) engaged into each other substantially without play, in at least two zones of the parts spaced from each other in the axial direction of the parts (1, 2) two small protuberances (4) projecting radially outwards of the parts (1, 2) separated from each other, along the circumference of the parts (1, 2), by portions of the intermediate walls (5) of the parts. The small protuberances (4) are simultaneously produced in two zones spaced in the axial direction of the tubular parts (1, 2), using a tool comprising an expander with flexible blades on each of which are arranged two bosses spaced from each other in the expander axial direction. The invention is particularly useful for fixing an end sleeve (1) on a guide tube (2) of a fuel assembly.

The invention relates to a method for connecting two coaxial tubular parts and a tool for connecting the parts.

The method and the tool according to the invention are used in particular to connect a guide tube of a fuel assembly and an end sleeve of the guide tube.

Fuel assemblies for nuclear reactors cooled by water and in particular by pressurized water comprise a framework in which fuel rods are held in the form of a bundle in which the rods are all parallel to each other. The framework of the fuel assembly comprises spacer grids for transversely and axially holding the rods in a regular array, guide tubes parallel to the rods placed in certain positions inside the bundle and end nozzles. The guide tubes, which constitute structural elements of the framework of the fuel assembly and which can be used to guide absorbent rods of the control rod clusters of the nuclear reactor, have a length greater than the length of the rods and comprise end portions allowing them to be fixed to the nozzles of the fuel assembly. The upper end portions of the guide tubes, which are fastened to the top nozzle of the fuel assembly, may consist of sleeves engaged substantially without play on the ends of the guide tubes, in a coaxial arrangement. These end sleeves of the guide tubes may comprise, for example, a threaded portion or flexible blades for engaging in an opening of the top nozzle of the fuel assembly, for fuel assemblies whose top nozzle is removable, it being possible the guide tube and the fuel assembly to be connected by screwing a threaded sleeve or by a locking sleeve.

A connection between the guide tube and its end sleeve has to be provided such that the guide tube and the sleeve are locked both in axial translation and in rotation about their common axis. This connection must be produced without welding, because of the nature of the materials forming the guide tubes, the methods of manufacturing the fuel assembly components and the mechanical strength and corrosion resistance properties required of the components forming the fuel assembly. The guide tubes must also be assembled with penetration sleeves of the spacer grid cells by a method without welding.

In order to connect a guide tube and a sleeve in which the guide tube is engaged, methods of connecting by diametrally expanding the walls of the guide tube and of the sleeve, engaged one on the other, have been proposed, mainly when the materials of the guide tube and of the sleeve are different.

For example, it has been proposed to produce the diametral expansion along a continuous annular region, by using a rotating roller-expansion tool.

With such a method, it is not possible to provide very good locking in rotation of the sleeve with respect to the guide tube.

The production, in the junction regions of the tube and of the sleeve, of protuberances projecting radially outward from the guide tube and from the sleeve, in at least two circumferential regions of the parts to be assembled spaced one from the other in the axial direction, has also been proposed. In each of the circumferential regions of the tubular parts to be assembled, at least two radially-projecting protuberances and generally four protuberances are produced, separated one from the other, along the circumference of the parts, by portions of the walls of the parts which are matched to the deformation produced by the protuberances. The method makes it possible to provide a good mechanical connection between the tubular parts which are locked both in translation and in rotation in two circumferential regions of the parts.

To produce this diametral expansion, a tool is used, consisting of a tubular expander generally comprising four flexible blades separated by slots in the axial direction and a frustoconical actuating mandrel which is moved axially inside the expander in order to separate the blades inside the parts to be connected by radial expansion of their walls.

The connection on each of the guide tubes of a fuel assembly is an operation which is generally lengthy and tricky, to the extent that the protuberances have to be formed successively, in a first region and in a second circumferential region of the tubular parts. Placing the expander inside the guide tube is a tricky operation, since the protuberances have to be very accurately oriented and aligned in the axial direction. In order to provide good mechanical attachment of the tubular parts one on the other, protuberances generally have to be produced, having a considerable depth in the radial direction, with respect to the dimensions of the tubular parts, which increases the difficulty of the operation. It is also difficult to provide an attachment without play, in particular in the axial direction, because of the elastic behavior of the material of the walls during the expansion operation and after this operation.

In addition, the tube and the sleeve undergo a reduction in surface area between the deformed regions, which alters their dimensional characteristics.

The aim of the invention is therefore to propose a method for connecting two coaxial tubular parts engaged one inside the other, over at least a portion of their length in an axial direction, consisting in producing, by radial expansion of the walls of the two tubular parts, in the portion of the parts engaged together, in at least two regions of the parts spaced one from the other in the axial direction, at least two protuberances projecting radially outward, separated one from the other, along the circumference of the parts, by portions of intermediate walls of the parts, this method making it possible to obtain a very efficient mechanical connection without play, with very high productivity and a protuberance depth which is small in the radial direction of the protuberances thereby limiting the reduction in surface area of the parts.

To this end, the protuberances are produced simultaneously by radial expansion of the walls of the tubular parts in the two regions spaced in the axial direction.

The invention also relates to an expansion tool for connecting the tubular parts, comprising an expander whose flexible blades each comprise two protuberances for forming an imprint in the walls of the tubular parts, spaced one from the other in the axial longitudinal direction of the blades.

In order, for the invention to be better understood, a connection between a guide tube and an end sleeve, the production of this connection by the method of the invention and an expansion tool to produce the connection will now be described by way of example, with reference to the appended figures.

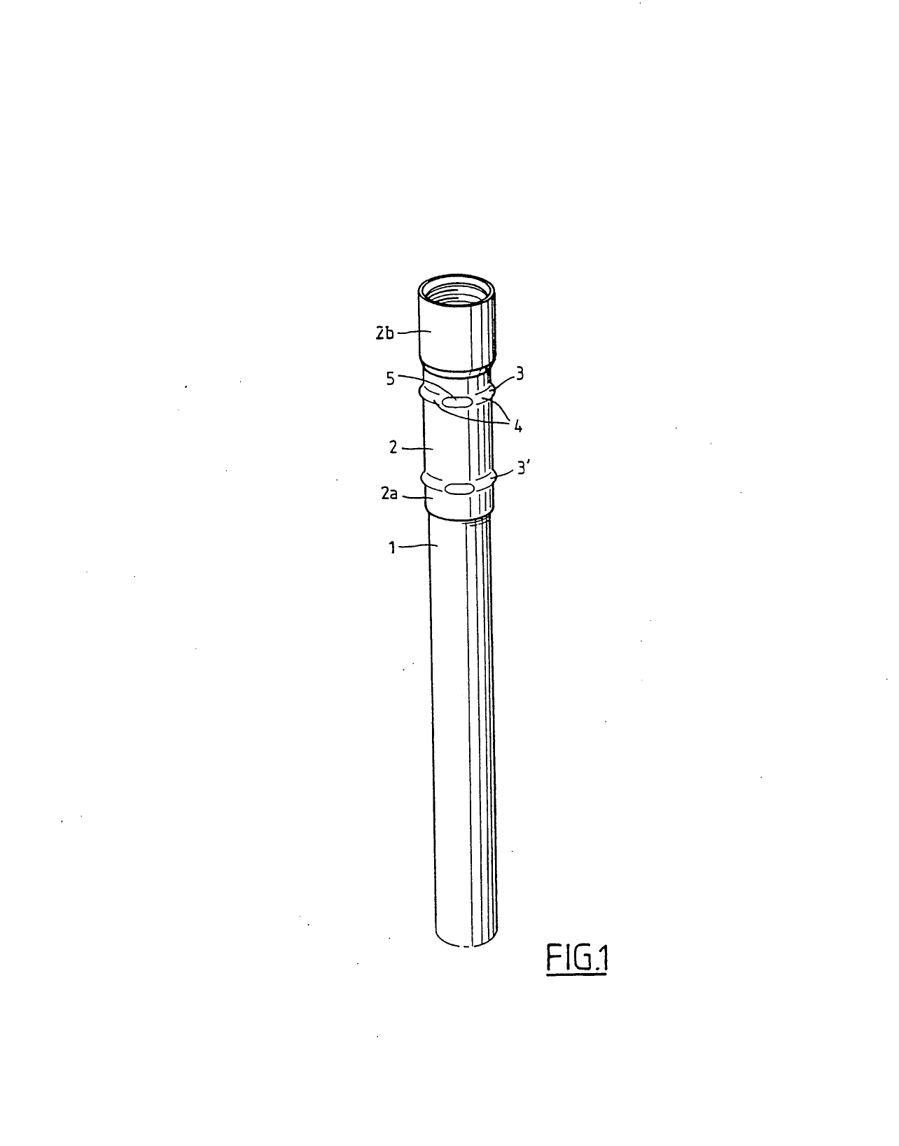

FIG. 1 is a perspective view of an end portion of a guide tube bearing a sleeve fastened to the guide tube by the method of the invention.

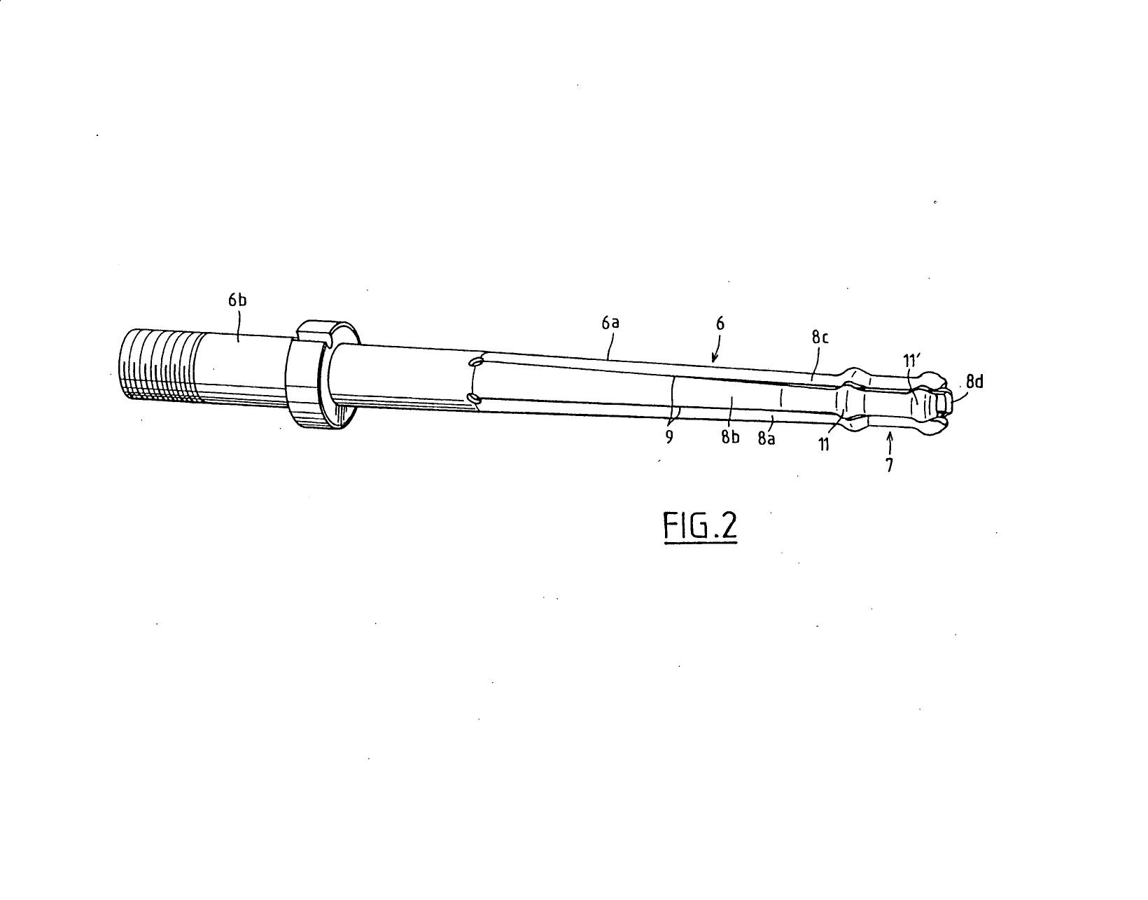

FIG. 2 is a perspective view of an expander for an expansion tool in order to carry out the method of the invention.

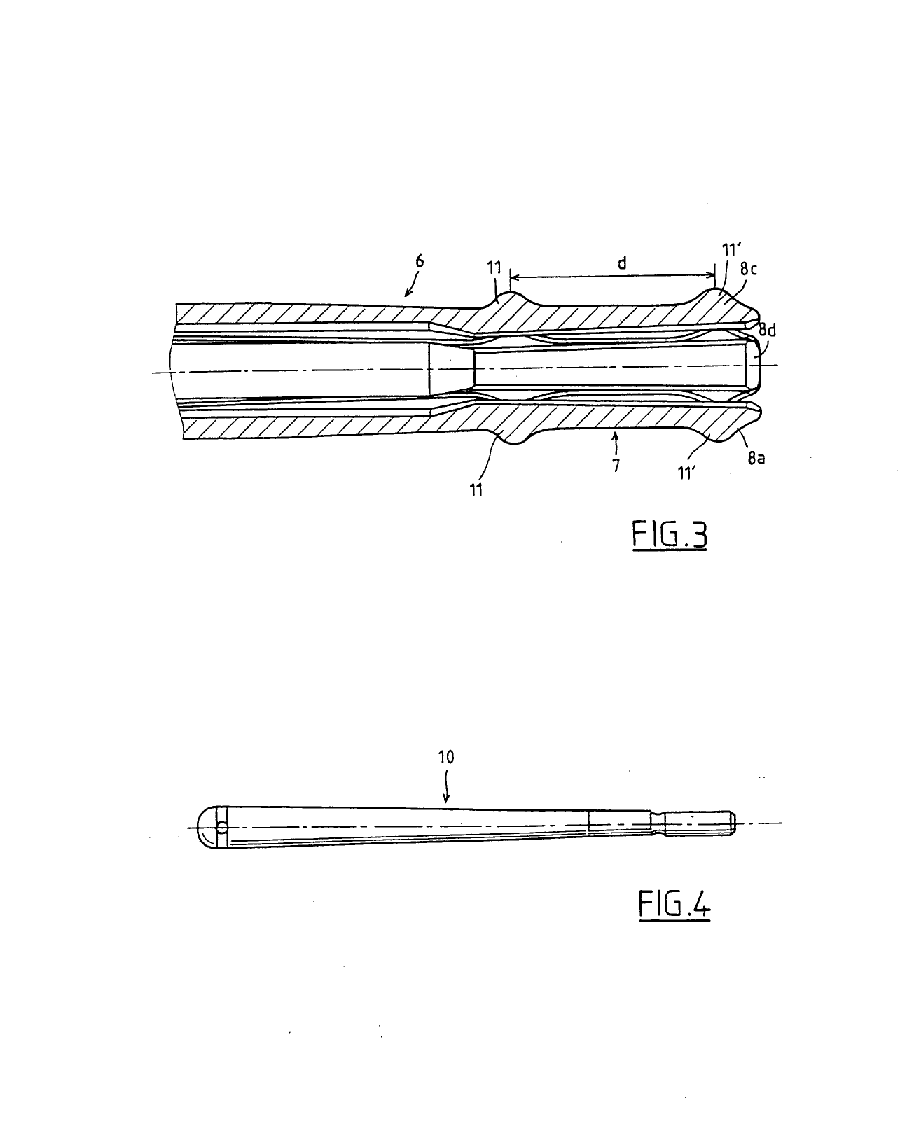

FIG. 3 is a view in enlarged axial section of the end portion of the expander.

FIG. 4 is a side view of the actuating mandrel of the expander.

FIG. 1 shows an upper end portion of a guide tube 1 of a fuel assembly constituting the upper end portion of the guide tube to which is engaged and fastened an end sleeve 2 via which it is possible to attach the guide tube by a mechanical connection screwed into the top nozzle of the fuel assembly.

The guide tube 1 is generally made of a zirconium alloy and the end nozzle 2 may be made of a different material, for example, of stainless steel.

The sleeve 2 comprises a tubular-shaped body 2a whose internal diameter is substantially equal to the external diameter of the guide tube 1 (diameter from 12 to 14 mm) and an end portion 2b which is diametrally enlarged and internally threaded. The end of the guide tube 1 can be fitted into the top nozzle of the fuel assembly using an insert which is screwed inside the threaded portion of the end 2b of the sleeve 2.

The guide tube 1 and the end sleeve 2 are connected such that the two tubular parts are locked one with respect to the other in axial translation and in rotation about their common axis, by deforming the walls of the two tubular parts 1 and 2 engaged one on the other in a coaxial arrangement, in two regions 3 and 3′ spaced one from the other in the axial direction of the tubular parts 1 and 2.

The two deformed regions 3 and 3′ are identical so only the region 3 will be described. The deformed region 3 comprises four protuberances 4 (two protuberances are visible in FIG. 1), projecting radially outward from the tubular parts 1 and 2 and having substantially the shape of toric sections. The four protuberances 4 are placed at 90° one from the other about the axis of the tubular parts 1 and 2 and are produced by expanding the walls of the sleeve 2 and of the guide tube 1 which is engaged in the sleeve 2 up to the end portion 2b.

Two successive protuberances 4 in a deformation region such as 3 or 3′ are separated by a portion 5 of the walls of the two tubular parts accommodating the deformation of the protuberances 4 between which it is placed.

In order to produce the connection shown in FIG. 1 by the method of the invention, the guide tube 1 is engaged in a sleeve, then, in a single operation which will be described below, the two parts 1 and 2 are expanded in the regions 3 and 3′.

This method is implemented using an expansion tool which will be described below.

The expansion tool mainly comprises an expander which is shown in FIGS. 2 and 3 and a mandrel for actuating the expander, which is shown in FIG. 4.

The expander, shown in FIGS. 2 and 3 and generally denoted by the reference 6, comprises an elongate body of tubular shape, a first portion 6a of which constitutes the actual expander and a second end part 6b, a portion for mounting the tool on a tool support. The portion 6a of the expander 6 comprises, at one of its ends, the expansion head 7 via which, inside the tubular parts, recessed imprints are produced on their internal portion and radially-projecting protuberances are produced on their outer surface.

In its portion 6a forming the actual expander, the body of the expander 6 forms four flexible blades 8a, 8b, 8c and 8d, lying in the axial longitudinal direction of the expander 6.

The blades 8a, 8b, 8c and 8d consist of sections which are cut and machined in the tubular wall of the body of the expander. The wall of the tubular body of the expander comprises four slot 9 each separating two successive blades of the expander and extending over the greatest length of the part 6a of the expander body, between the end of the expander head 7 and a region close to the support portion 6b of the expander. The blades 8a, 8b, 8c and 8d, secured to the expander body at their end opposite the expansion head 7, can be separated one from the others to produce the expansion, each of the flexible blades then being deformed by elastic bending.

The separation of the blades in radial directions is obtained by introducing, by traction, the frustoconical mandrel 10 shown in FIG. 4 into the central bore of the expansion head 7.

The expander body 6, in its portion 6a, has an external diameter less than the internal diameter of a guide tube, such that the expander can be introduced inside the guide tube on which is engaged, in a coaxial position, an end sleeve which is to be connected with the guide tube. The expansion head 7 is introduced in a portion of the guide tube engaged inside the sleeve in order to connect the guide tube and the sleeve by expansion and crimping, as will be described below.

As can be seen in FIGS. 2 and 3, each of the blades 8a, 8b, 8c and 8 of the expander 6 has, in its end portion constituting the expansion head 7, a shape and a profile matched to the simultaneous production of two imprints and protuberances in the walls of the guide tube and of the end sleeve. Each of the blades 8a, 8b, 8c and 8d comprises, in its end portion, a first and a second expansion protuberance 11 and 11′ having substantially the shape of a toroidal segment, projecting outward from the head 7 of the expander.

FIG. 3, which is a view in axial section of the expander head, shows the meridian profile of the outer surface of the end portion of the blades 8a and 8c, whose protuberances 11 and 11′ form two undulations separated by a distance d, in the axial direction of the expander 6. The first and second protuberances 11 and 11′ of the various successive blades 8a, 8b, 8c and 8d are aligned along a first and a second circumferential line of the expander 6 and respectively centered with respect to two expander cross-section planes, separated by the distance d.

The meridian profile of the protuberances 11 and 11′ which is matched to producing the expansion and the crimping of the tubular parts 1 and 2 in order to efficiently fit the parts one over the other, may comprise for example, a central portion, an internal portion directed toward the second protuberance and an opposite external portion, these three portions being curved.

The three portions of the meridian profile of the protuberances are connected at points of inflection of this profile, the central portion of the protuberance being convex outward from the expander and the internal and external portions being outwardly concave.

Two pairs of successive protuberances 11, 11′ of an expander blade are separated by a slot 9 and the set of successive protuberances 11 together with the set of successive protuberances 11′ constitute substantially toric deformation surfaces in four portions separated by the slots 9.

When the blades of the expander, whose head 7 is placed inside a portion of the guide tube engaged in an end sleeve, is expanded, the protuberances 11 and 11′ of each of the blades of the expander moved outward by traction on the actuator 10, produce in the walls in contact with the guide tube and of the sleeve, imprints aligned along two circumferential directions of the tube and of the sleeve. The imprints, which are recessed in the internal surface of the guide tube and of the sleeve, result in protuberances on the external surface of the sleeve and of the guide tube, these protuberances being produced simultaneously along the two circumferential lines, so as to perfectly fit together one in the other.

The curved profiles of the toric protuberances 11 and 11′ described above make it possible to produce a progressive (but very east) deformation of the metal of the walls of the guide tube and of the sleeve and thus to reduce the tensile stresses being exerted between the two protuberances being formed.

The fact that deformation of the walls produces tensile stresses between the protuberances makes it possible to cancel the axial play which may remain between the protuberances on the elastic return of the metal at the end of forming.

The advantages stated above linked to the simultaneous production of two lines of circumferential protuberances in the tubular parts make it possible to obtain a satisfactory effect of catching and locking the tubular parts, while limiting the depth of the imprints of the protuberances made during the expansion of the tubular parts. In this way, it has been possible to considerably reduce the height of the protuberances made in the tubular parts, compared with a method in which each of the circumferential lines of protuberances is carried out successively. It has been possible to reduce this depth of the imprints or protuberances by 20 to 40% for equal connection strength. Thus the stress of the metal located between the protuberances and therefore the reduction in surface area have been reduced.

Of course, in order to simultaneously produce the two lines of protuberances in the tubular parts, it is necessary to exert a greater force on the tooling in order to move the actuating mandrel inside the expander.

In order to limit the risks of the contacting surfaces of the conical actuator and of the expander seizing during movement of the actuator in the axial direction, while giving these tooling parts mechanical properties which allow them to carry out their functions, the actuator or conical mandrel may, for example, be made from a treated structural steel in order to exhibit a hardness greater than 65 HRC and coated with a layer of carbon-doped titanium nitride with a hardness of, for example, between 2500 and 4000 HV.

The expander may be made from a treated structural steel having a hardness greater than 55 HRC and comprising an external coating consisting of hard chromium plate, this outer coating having a hardness at least equal to 850 HV. It is possible to use a machine equipped with a single tool comprising an expander 6 and a conical actuator 10 or, in contrast, an automatic machine making it possible to simultaneously actuate a set of expansion tools. Such a machine equipped with twenty-four tools can carry out simultaneously and in a single operation the crimping of end sleeves on the twenty-four guide tubes of a fuel assembly.

The invention therefore has the advantage of considerably increasing the productivity within the scope of manufacturing components of a fuel assembly and of reducing the height of the expanded portions of the walls of the tubular parts and therefore of reducing the stresses in these parts. In addition, the reduction in surface area of the tube between the expanded portions or protuberances, is prevented, which makes it possible to carry out the expansion operation with an expander which does not have branches for holding the walls of the tubular parts, between the expansion blades.

The method and the device of the invention also make it possible, because of the limitation on stresses, to preserve high mechanical properties for the tubular parts which are being connected.

Of course, the invention is not strictly limited to the embodiment which has been described; for example, it is possible to use an expansion tool comprising a number of blades other than four. However, the tool must comprise at least two blades each having two protuberances.

The invention is applicable not only to the connection of guide tubes of fuel assemblies with sleeves in which these guide tubes are engaged but also in all cases where coaxial tubular parts are connected, whatever the functions and purposes of these parts.

1-5. (canceled)

6. A method for connecting two coaxial tubular parts engaged one inside the other, over at least a portion of their length in their common axial direction, consisting in producing, by radial expansion of the walls of the two tubular parts, in the portion of the parts engaged together, in at least two regions of the parts spaced one from the other in the axial direction, at least two protuberances projecting radially outward from the parts separated one from the other, along the circumference of the parts by portions of intermediate walls of the parts, wherein the protuberances are produced simultaneously by radial expansion of the walls of the tubular parts in the two regions spaced in the axial direction so as to subject the tubular parts to tensile stresses, between the spaced-out regions, without a reduction in surface area of the tubular parts.

7. A tool for connecting two coaxial tubular parts engaged one inside the other, over at least a portion of their length in the axial direction, comprising an expander having a tubular body whose external diameter is less than the internal diameter of the internal tubular part comprising, over a portion of its length in the axial direction, slots passing through its wall and delimiting at least two and, for example, four flexible blades exhibiting profiled end portions forming an expansion head and a conical actuator for spreading the blades of the expander by axial displacement inside the expander, wherein each of the blades of the expander comprises, in its profiled end portion, a first protuberance and a second protuberance separated one from the other by a distance (d) in the axial direction of the expander, the first protuberances and the second protuberances of the flexible blades of the expander being aligned along a first and along a second circumferential line on the outer surface of the expander.

8. The tool as claimed in claim 7, wherein each of the protuberances of an end portion of a flexible blade of the expander exhibits overall the shape of a segment of torus and a meridian profile comprising a central part which is convex outward from the expander and two end portions which are concave outward from the expander.

9. The tool as claimed in claim 7, wherein the conical actuator of the tool is made from a treated structural steel in order to exhibit a hardness greater than 65 HRC and coated with a layer of carbon-doped titanium nitride with a hardness of between 2500 and 4000 HV, the expander of the tool being made from a treated structural steel in order to exhibit a hardness greater than 55 HRC and coated on the outside with a layer produced by hard chromium plating with a hardness greater than 850 HV.

10. The method of claim 6 further comprising the step of connecting a guide tube of a fuel assembly of a water-cooled nuclear reactor and a sleeve, such as an end sleeve, in which the guide tube is engaged substantially without play.
